(19) United States
(12) Patent Application Publication
(10) Pub. No.: US 2026/0249240 A1
(43) Pub. Date: Aug. 27, 2026

(54) MODULAR HONEYCOMB CERAMIC REGENERATOR

(71) Applicant: FUJIAN JUNGIE NEW MATERIAL TECHNOLOGY CO., LTD., Ningde (CN)

(72) Inventors: Wenzhong WU, Ningde (CN); Jinxin LI, Ningde (CN); Yuechan ZHANG, Ningde (CN); Qi ZHUANG, Ningde (CN); Hongfa LI, Ningde (CN)

(21) Appl. No.: 19/644,982

(22) Filed: Apr. 10, 2026

(51) Int. Cl. B01D 53/76; B01D 53/34

(52) U.S. Cl. CPC B01D 53/76; B01D 53/343; B01D 2259/65

(57) ABSTRACT

A modular honeycomb ceramic regenerator, including a plurality of ceramic units spliced together in a horizontal direction. Each of the plurality of ceramic units includes a supporting frame and a plurality of slotted holes provided within the supporting frame. Each of the plurality of slotted holes is provided with at least one first protrusion. An outer side of the supporting frame is provided with a plurality of second protrusions. Second protrusions between adjacent ceramic units are configured to enclose an interlocking hole.

### TECHNICAL FIELD

This application relates to ceramic products, and more particularly to a modular honeycomb ceramic regenerator.

### BACKGROUND

Currently, honeycomb ceramic regenerators used in regenerative thermal oxidizers are typically in the form of regular cubes or rectangular prisms with smooth outer walls. However, these structural designs will lead to the following problems during use:
1. The outer walls of the honeycomb ceramic are often subject to some degree of warping and deformation; the greater the height, the more significant the deformation; This warped outer wall causes the honeycomb ceramic regenerator to occupy more space during installation and use; This additional space does not contain gas flow channels, thereby blocking the ventilation holes between upper and lower layers of honeycomb ceramics, increasing the pressure drop of the honeycomb ceramic regenerators; Moreover, the airflow resistance at the outer wall portions is far greater than that within the honeycomb channels, resulting in uneven airflow distribution and reducing the actual thermal efficiency of the honeycomb ceramic regenerators; and
2. Due to limitations of production equipment, the cross-sectional area of the honeycomb ceramic regenerators is typically 150 mm × 150 mm, with a height of 100-300 mm, resulting in a relatively small volume, which increases installation difficulty and cost.

### SUMMARY

An object of the disclosure is to provide a modular honeycomb ceramic regenerator having uniform airflow distribution and configurable dimensions.

Technical solutions of the present disclosure are described as follows.

A modular honeycomb ceramic regenerator, comprising:

a plurality of ceramic units spliced together in a horizontal direction;

wherein each of the plurality of ceramic units comprises a supporting frame and a plurality of slotted holes provided within the supporting frame;

each of the plurality of slotted holes is provided with at least one first protrusion;

an outer side of the supporting frame is provided with a plurality of second protrusions; and

second protrusions of adjacent ceramic units among the plurality of ceramic units are configured to enclose an interlocking hole.

In some embodiments, the supporting frame is rectangular.

In some embodiments, each of the plurality of ceramic units has a length of 100-150 mm, a width of 100-150 mm and a height of 100-150 mm.

In some embodiments, each of the plurality of slotted holes is rectangular.

In some embodiments, the number of the at least one first protrusion in each of the plurality of slotted holes is 1-5.

In some embodiments, the interlocking hole is a circular hole.

In some embodiments, the interlocking hole is a hexagonal hole.

In some embodiments, the interlocking hole is a square hole.

In some embodiments, the interlocking hole has a width of 0.5-1.5 mm and a maximum length of 1.5-12.5 mm.

In some embodiments, the interlocking hole is rectangular, and has a width of 0.75 mm and a length of 7 mm.

Compared to the prior art, the present disclosure has the following beneficial effects.

In the present disclosure, the modular honeycomb ceramic regenerator is provided with second protrusions, thereby overcoming the drawbacks of conventional honeycomb ceramics in which the outer walls lack ventilation holes, resulting in increased airflow resistance at portions of the outer walls and uneven airflow distribution. As a result, local gas pressure drop is reduced, airflow distribution is rendered more uniform, and system thermal efficiency is improved. The ceramic units can be spliced to achieve arbitrary dimensions to accommodate a wider range of operating conditions, and can improve the flatness and regularity of the honeycomb ceramic end faces and enhance the product’s ability to resist destructive stress within a regenerator chamber. Furthermore, installation difficulty and installation cost are reduced.

### BRIEF DESCRIPTION OF THE DRAWINGS

FIG. 1 is a structural diagram of a plurality of ceramic units of a modular honeycomb ceramic regenerator in a spliced state, according to an embodiment of the present disclosure; and

FIG. 2 is a side view of the plurality of ceramic units of the modular honeycomb ceramic regenerator in the spliced state, according to an embodiment of the present disclosure.

In the figures: 1-supporting frame; 11-second protrusion; 2-slotted hole; and 21-first protrusion.

### DETAILED DESCRIPTION OF EMBODIMENTS

For a detailed description of the technical content, objectives, and effects of the present disclosure, the following description is provided in conjunction with the embodiments and accompanying drawings.

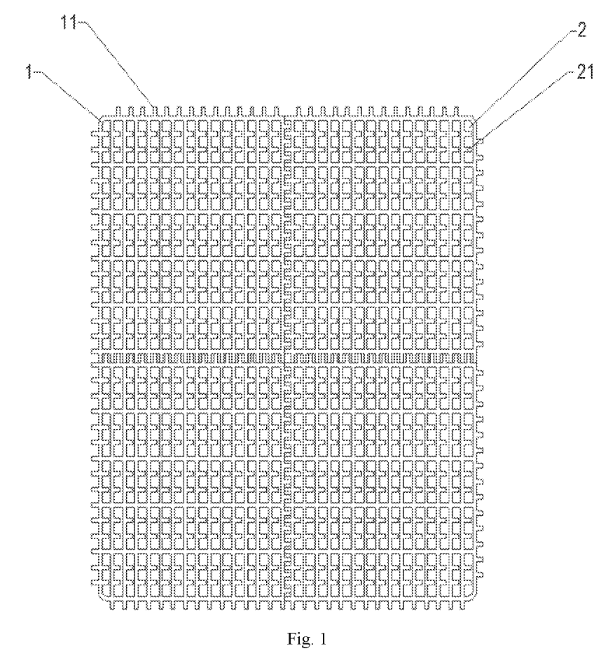

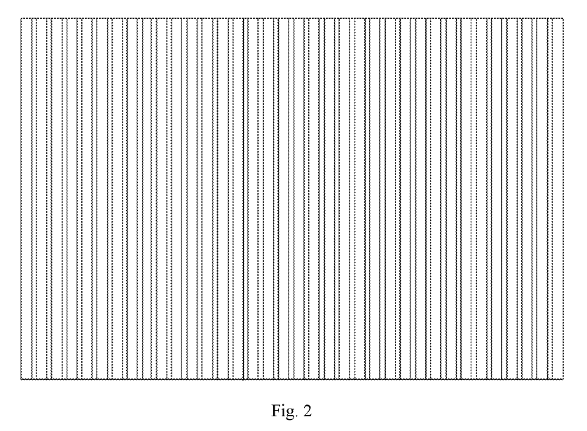

As shown in FIGS. 1-2, an embodiment of the present disclosure provides a modular honeycomb ceramic regenerator, including a plurality of ceramic units spliced together in a horizontal direction. Each of the plurality of ceramic units includes a supporting frame 1 and a plurality of slotted holes 2 provided within the supporting frame 1. Each of the plurality of slotted holes 2 is provided with at least one first protrusion 21. An outer side of the supporting frame 1 is provided with a plurality of second protrusions 11. Second protrusions 11 of adjacent ceramic units among the plurality of ceramic units are configured to enclose an interlocking hole.

In the present disclosure, the modular honeycomb ceramic regenerator is provided with second protrusions, thereby overcoming the drawbacks of conventional honeycomb ceramics in which the outer walls lack ventilation holes, resulting in increased airflow resistance at portions of the outer walls and uneven airflow distribution. As a result, local gas pressure drop is reduced, airflow distribution is rendered more uniform, and system thermal efficiency is improved. The ceramic units can be spliced to achieve arbitrary dimensions to accommodate a wider range of operating conditions, and can improve the flatness and regularity of the honeycomb ceramic end faces and enhance the product’s ability to resist destructive stress within a regenerator chamber. Furthermore, installation difficulty and installation cost are reduced.

In some embodiments, the supporting frame 1 is rectangular.

The supporting frame 1 is rectangular to provide improved structural stability.

In some embodiments, each of the plurality of ceramic units has a length of 100-150 mm, a width of 100-150 mm and a height of 100-150 mm.

In some embodiments, each of the plurality of slotted holes 2 is rectangular.

Each slotted hole 2 is rectangular, and is provided with the at least one first protrusion 21, thereby enhancing the thermal efficiency of the ceramic regenerator.

In some embodiments, the number of the at least one first protrusion 21 in each of the plurality of slotted holes 2 is 1-5.

In some embodiments, the interlocking hole is a circular hole.

In some embodiments, the interlocking hole is a hexagonal hole.

In some embodiments, the interlocking hole is a square hole.

In some embodiments, the interlocking hole has a width of 0.5-1.5 mm and a maximum length of 1.5-12.5 mm.

In some embodiments, the interlocking hole is rectangular, and has a width of 0.75 mm and a length of 7 mm.

### EXAMPLE 1

As shown in FIGS. 1-2, an embodiment of the present disclosure provides a modular honeycomb ceramic regenerator, including a plurality of ceramic units spliced together in a horizontal direction. Each of the plurality of ceramic units includes a supporting frame 1 and a plurality of slotted holes 2 provided within the supporting frame 1. Each of the plurality of slotted holes 2 is provided with at least one first protrusion 21. An outer side of the supporting frame 1 is provided with a plurality of second protrusions 11. Second protrusions 11 of adjacent ceramic units among the plurality of ceramic units are configured to enclose an interlocking hole.

In this embodiment, the supporting frame 1 is rectangular. Each of the plurality of ceramic units has a length of 100-150 mm, a width of 100-150 mm and a height of 100-150 mm.

In this embodiment, each of the plurality of slotted holes 2 is rectangular, and the number of the at least one first protrusion 21 in each of the plurality of slotted holes 2 is 1-5.

In this embodiment, the interlocking hole is a square hole. The square hole has a width of 0.75 mm and a length of 7 mm.

An inorganic high-temperature-resistant adhesive is coated between the second protrusions of adjacent ceramic units to form an interlocking bond, whereby a modular honeycomb ceramic regenerator having a length, width, and height each ranging from 100 mm to 1000 mm can be spliced according to use requirements.

The modular honeycomb ceramic regenerator is prepared through the following steps. A conventional regular honeycomb ceramic regenerator is modified by changing the material from an aluminosilicate material to a high-silica material having a silicon dioxide content of 65% to 80%. The forming process is changed to a wet forming process, and no plasticizer or other organic additives are added to the material, thereby improving product density. In the structural design, a plurality of slots (second protrusions) are formed on the planar outer walls of the honeycomb ceramic. The slots enable adjacent honeycomb ceramic units to be spliced according to required dimensions, and ventilation holes of predetermined sizes are reserved between adjacent slots. An inorganic high-temperature-resistant adhesive is applied to surfaces of the slots on the outer walls, such that the spliced honeycomb ceramic units maintain bonding at an operating temperature of 1200 °C.

The modular honeycomb ceramic regenerator provides the following advantages:
1. The modular honeycomb ceramic regenerator overcomes the drawback of conventional honeycomb ceramics in which the outer walls lack ventilation holes, leading to increased airflow resistance at the outer walls and uneven airflow distribution, thereby reducing local gas pressure drop, promoting more uniform airflow distribution, and improving system thermal efficiency;
2. By using a high-silica material and a wet forming process, the honeycomb ceramic regenerator provided herein exhibits improved product density, reduces adhesion of gaseous impurities such as silicon dioxide and titanium dioxide during operation, decreases blockage of gas flow channels, and further enhances thermal efficiency;
3. The ceramic units can be spliced to form arbitrary dimensions to accommodate a wider range of operating conditions, improves the flatness and regularity of honeycomb ceramic end faces, and enhances resistance to destructive stress within a regenerator chamber; and
4 The modular honeycomb ceramic regenerator provided herein reduces installation difficulty and installation cost.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A modular honeycomb ceramic regenerator, comprising:
a plurality of ceramic units spliced together in a horizontal direction;
wherein each of the plurality of ceramic units comprises a supporting frame and a plurality of slotted holes provided within the supporting frame;
each of the plurality of slotted holes is provided with at least one first protrusion;
an outer side of the supporting frame is provided with a plurality of second protrusions; and
second protrusions of adjacent ceramic units among the plurality of ceramic units are configured to enclose an interlocking hole.

2. The modular honeycomb ceramic regenerator of claim 1, wherein the supporting frame is rectangular.

3. The modular honeycomb ceramic regenerator of claim 2, wherein each of the plurality of ceramic units has a length of 100-150 mm, a width of 100-150 mm and a height of 100-150 mm.

4. The modular honeycomb ceramic regenerator of claim 1, wherein each of the plurality of slotted holes is rectangular.

5. The modular honeycomb ceramic regenerator of claim 4, wherein the number of the at least one first protrusion in each of the plurality of slotted holes is 1-5.

6. The modular honeycomb ceramic regenerator of claim 1, wherein the interlocking hole is a circular hole.

7. The modular honeycomb ceramic regenerator of claim 1, wherein the interlocking hole is a hexagonal hole.

8. The modular honeycomb ceramic regenerator of claim 1, wherein the interlocking hole is a square hole.

9. The modular honeycomb ceramic regenerator of claim 1, wherein the interlocking hole has a width of 0.5-1.5 mm and a maximum length of 1.5-12.5 mm.

10. The modular honeycomb ceramic regenerator of claim 1, wherein the interlocking hole is rectangular, and has a width of 0.75 mm and a length of 7 mm.
